(19) United States
(12) Patent Application Publication
(10) Pub. No.: US 2007/0094011 A1
(43) Pub. Date: Apr. 26, 2007

(54) Removing time delays in signal paths

(76) Inventors: Hee Suk Pang, Seoul (KR); Dong Soo Kim, Seoul (KR); Jae Hyun Lim, Seoul (KR); Hyen O. Oh, Goyang-si (KR); Yang Won Jung, Seoul (KR)

Correspondence Address: FISH & RICHARDSON P.C., PO BOX 1022, MINNEAPOLIS, MN, 55440-1022, US

(21) Appl. No.: 11/540,920

(22) Filed: Sep. 29, 2006

Related U.S. Application Data
(60) Provisional application No. 60/729,225, filed on Oct. 24, 2005.
(60) Provisional application No. 60/792,329, filed on Apr. 17, 2006.
(60) Provisional application No. 60/786,740, filed on Mar. 29, 2006.
(60) Provisional application No. 60/757,005, filed on Jan. 9, 2006.

(30) Foreign Application Priority Data
Aug. 18, 2006 (KR) 10-2006-0078218
Aug. 18, 2006 (KR) 10-2006-0078221
Aug. 18, 2006 (KR) 10-2006-0078219
Aug. 18, 2006 (KR) 10-2006-0078225
Aug. 18, 2006 (KR) 10-2006-0078223
Aug. 18, 2006 (KR) 10-2006-0078222

(51) Int. Cl. G10L 19/02

(52) U.S. Cl. 704/204

(57) ABSTRACT

The disclosed embodiments include systems, methods, apparatuses, and computer-readable mediums for compensating one or more signals and/or one or more parameters for time delays in one or more signal processing paths.

### RELATED APPLICATIONS

This application claims the benefit of priority from the following U.S. and Korean patent applications:
U.S. Provisional Patent Application No. 60/729,225, filed Oct. 4, 2005;
U.S. Provisional Patent Application No. 60/757,005, filed Jan. 9, 2006;
U.S. Provisional Patent Application No. 60/786,740, filed Mar. 29, 2006;
U.S. Provisional Patent Application No. 60/792,329, filed Apr. 17, 2006;
Korean Patent Application No. 10-2006-0078218, filed Aug. 18, 2006;
Korean Patent Application No. 10-2006-0078221, filed Aug. 18, 2006;
Korean Patent Application No. 10-2006-0078222, filed Aug. 18, 2006;
Korean Patent Application No. 10-2006-0078223, filed Aug. 18, 2006;
Korean Patent Application No. 10-2006-0078225, filed Aug. 18, 2006; and
Korean Patent Application No. 10-2006-0078219, filed Aug. 18, 2006.

Each of these patent applications is incorporated by reference herein in its entirety.

### TECHNICAL FIELD

The disclosed embodiments relate generally to signal processing.

### BACKGROUND

Multi-channel audio coding (commonly referred to as spatial audio coding) captures a spatial image of a multi-channel audio signal into a compact set of spatial parameters that can be used to synthesize a high quality multi-channel representation from a transmitted downmix signal.

In a multi-channel audio system, where several coding schemes are supported, a downmix signal can become time delayed relative to other downmix signals and/or corresponding spatial parameters due to signal processing (e.g., time-to-frequency domain conversions).

### SUMMARY

The disclosed embodiments include systems, methods, apparatuses, and computer-readable mediums for compensating one or more signals and/or one or more parameters for time delays in one or more signal processing paths.

In some embodiments, a method of processing an audio signal includes: receiving an audio signal including a downmix signal and spatial information; converting the downmix signal from a first domain to a second domain; and combining the converted downmix signal and the spatial information, wherein at least one of the combined downmix signal and the combined spatial information is delayed by amount of time that includes an elapsed time of the converting.

In some embodiments, a system for generating a plural-channel audio signal includes a downmix decoder configured for processing an encoded downmix signal. A plural-channel decoder is operatively coupled to the downmix decoder and configured for generating a plural-channel audio signal. A domain converter is included in the plural-channel decoder and configured for converting the downmix signal from a first domain to a second domain. A delay processor included in the plural-channel decoder and configured for compensating the downmix signal for time delay resulting from converting the downmix signal.

In some embodiments, a system for generating a plural-channel audio signal includes a domain converter configured for converting a downmix signal from a first domain to a second domain. A delay processor is operatively coupled to the domain converter and configured for compensating the converted downmix signal for time delay resulting from the conversion. A plural-channel audio processor is operatively coupled to the delay processor and configured for generating a plural-channel audio signal from the compensated downmix signal and spatial information.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1 to 3 are block diagrams of apparatuses for decoding an audio signal according to embodiments of the present invention, respectively;

FIG. 4 is a block diagram of a plural-channel decoding unit shown in FIG. 1 to explain a signal processing method;

FIG. 5 is a block diagram of a plural-channel decoding unit shown in FIG. 2 to explain a signal processing method; and

FIGS. 6 to 10 are block diagrams to explain a method of decoding an audio signal according to another embodiment of the present invention.

### DETAILED DESCRIPTION

Reference will now be made in detail to the preferred embodiments of the present invention, examples of which are illustrated in the accompanying drawings. Wherever possible, the same reference numbers will be used throughout the drawings to refer to the same or like parts.

Since signal processing of an audio signal is possible in several domains, and more particularly in a time domain, the audio signal needs to be appropriately processed by considering time alignment.

Therefore, a domain of the audio signal can be converted in the audio signal processing. The converting of the domain of the audio signal maybe include a T/F(Time/Frequency) domain conversion and a complexity domain conversion. The T/F domain conversion includes at least one of a time domain signal to a frequency domain signal conversion and a frequency domain signal to time domain signal conversion. The complexity domain conversion means a domain conversion according to complexity of an operation of the audio signal processing. Also, the complexity domain conversion includes a signal in a real frequency domain to a signal in a complex frequency domain, a signal in a complex frequency domain to a signal in a real frequency domain, etc. If an audio signal is processed without considering time alignment, audio quality may be degraded. A delay processing can be performed for the alignment. The delay processing can include at least one of an encoding delay and a decoding delay. The encoding delay means that a signal is delayed by a delay accounted for in the encoding of the signal. The decoding delay means a real time delay introduced during decoding of the signal.

Prior to explaining the present invention, terminologies used in the specification of the present invention are defined as follows.

‘Downmix input domain’ means a domain of a downmix signal receivable in a plural-channel decoding unit that generates a plural-channel audio signal.

‘Residual input domain’ means a domain of a residual signal receivable in the plural-channel decoding unit.

‘Time-series data’ means data that needs time synchronization with a plural-channel audio signal or time alignment. Some examples of ‘time series data’ includes data for moving pictures, still images, text, etc.

‘Leading’ means a process for advancing a signal by a specific time.

‘Lagging’ means a process for delaying a signal by a specific time.

‘Spatial information’ means information for synthesizing plural-channel audio signals. Spatial information can be spatial parameters, including but not limited to: CLD (channel level difference) indicating an energy difference between two channels, ICC (inter-channel coherences) indicating correlation between two channels), CPC (channel prediction coefficients) that is a prediction coefficient used in generating three channels from two channels, etc.

The audio signal decoding described herein is one example of signal processing that can benefit from the present invention. The present invention can also be applied to other types of signal processing (e.g., video signal processing). The embodiments described herein can be modified to include any number of signals, which can be represented in any kind of domain, including but not limited to: time, Quadrature Mirror Filter (QMF), Modified Discreet Cosine Transform (MDCT), complexity, etc.

A method of processing an audio signal according to one embodiment of the present invention includes generating a plural-channel audio signal by combining a downmix signal and spatial information. There can exist a plurality of domains for representing the downmix signal (e.g., time domain, QMF, MDCT). Since conversions between domains can introduce time delay in the signal path of a downmix signal, a step of compensating for a time synchronization difference between a downmix signal and spatial information corresponding to the downmix signal is needed. The compensating for a time synchronization difference can include delaying at least one of the downmix signal and the spatial information. Several embodiments for compensating a time synchronization difference between two signals and/or between signals and parameters will now be described with reference to the accompanying figures.

Any reference to an “apparatus” herein should not be construed to limit the described embodiment to hardware. The embodiments described herein can be implemented in hardware, software, firmware, or any combination thereof.

The embodiments described herein can be implemented as instructions on a computer-readable medium, which, when executed by a processor (e.g., computer processor), cause the processor to perform operations that provide the various aspects of the present invention described herein. The term “computer-readable medium” refers to any medium that participates in providing instructions to a processor for execution, including without limitation, non-volatile media (e.g., optical or magnetic disks), volatile media (e.g., memory) and transmission media. Transmission media includes, without limitation, coaxial cables, copper wire and fiber optics. Transmission media can also take the form of acoustic, light or radio frequency waves.

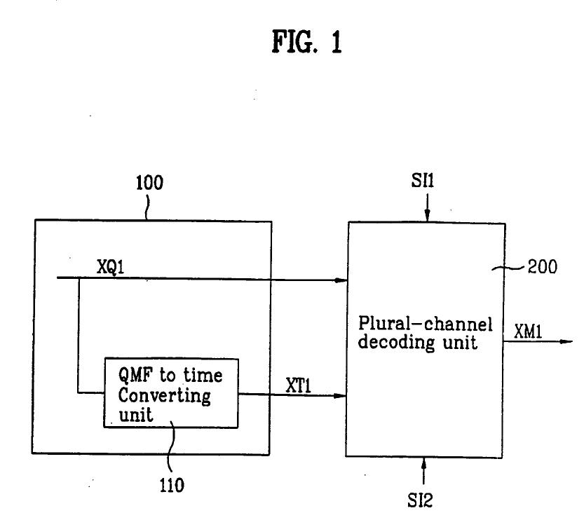

FIG. 1 is a diagram of an apparatus for decoding an audio signal according to one embodiment of the present invention.

Referring to FIG. 1, an apparatus for decoding an audio signal according to one embodiment of the present invention includes a downmix decoding unit 100 and a plural-channel decoding unit 200.

The downmix decoding unit 100 includes a domain converting unit 110. In the example shown, the downmix decoding unit 100 transmits a downmix signal XQ1 processed in a QMF domain to the plural-channel decoding unit 200 without further processing. The downmix decoding unit 100 also transmits a time domain downmix signal XT1 to the plural-channel decoding unit 200, which is generated by converting the downmix signal XQ1 from the QMF domain to the time domain using the converting unit 110. Techniques for converting an audio signal from a QMF domain to a time domain are well-known and have been incorporated in publicly available audio signal processing standards (e.g., MPEG).

The plural-channel decoding unit 200 generates a plural-channel audio signal XM1 using the downmix signal XT1 or XQ1, and spatial information SI1 or SI2.

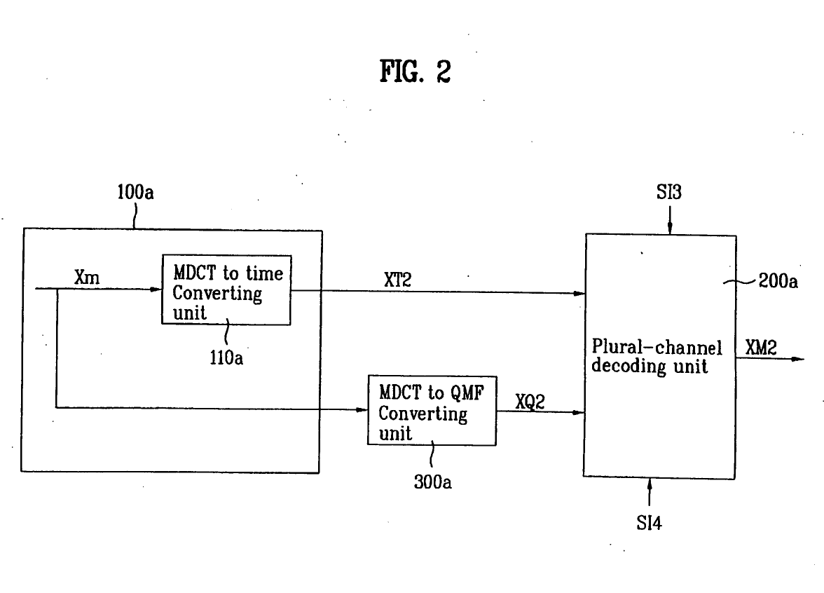

FIG. 2 is a diagram of an apparatus for decoding an audio signal according to another embodiment of the present invention.

Referring to FIG. 2, the apparatus for decoding an audio signal according to another embodiment of the present invention includes a downmix decoding unit 100a, a plural-channel decoding unit 200a and a domain converting unit 300a.

The downmix decoding unit 100a includes a domain converting unit 110a. In the example shown, the downmix decoding unit 100a outputs a downmix signal Xm processed in a MDCT domain. The downmix decoding unit 100a also outputs a downmix signal XT2 in a time domain, which is generated by converting Xm from the MDCT domain to the time domain using the converting unit 110a.

The downmix signal XT2 in a time domain is transmitted to the plural-channel decoding unit 200a. The downmix signal Xm in the MDCT domain passes through the domain converting unit 300a, where it is converted to a downmix signal XQ2 in a QMF domain. The converted downmix signal XQ2 is then transmitted to the plural-channel decoding unit 200a.

The plural-channel decoding unit 200a generates a plural-channel audio signal XM2 using the transmitted downmix signal XT2 or XQ2 and spatial information SI3 or SI4.

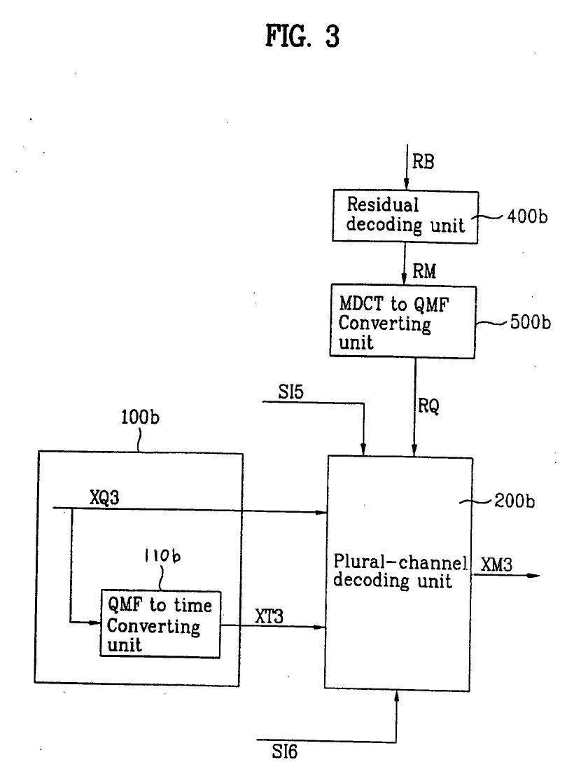

FIG. 3 is a diagram of an apparatus for decoding an audio signal according to another embodiment of the present invention.

Referring to FIG. 3, the apparatus for decoding an audio signal according to another embodiment of the present invention includes a downmix decoding unit 100b, a plural-channel decoding unit 200b, a residual decoding unit 400b and a domain converting unit 500b.

The downmix decoding unit 100b includes a domain converting unit 110b. The downmix decoding unit 100b transmits a downmix signal XQ3 processed in a QMF domain to the plural-channel decoding unit 200b without further processing. The downmix decoding unit 100b also transmits a downmix signal XT3 to the plural-channel decoding unit 200b, which is generated by converting the downmix signal XQ3 from a QMF domain to a time domain using the converting unit 110b.

In some embodiments, an encoded residual signal RB is inputted into the residual decoding unit 400b and then processed. In this case, the processed residual signal RM is a signal in an MDCT domain. A residual signal can be, for example, a prediction error signal commonly used in audio coding applications (e.g., MPEG).

Subsequently, the residual signal RM in the MDCT domain is converted to a residual signal RQ in a QMF domain by the domain converting unit 500b, and then transmitted to the plural-channel decoding unit 200b.

If the domain of the residual signal processed and outputted in the residual decoding unit 400b is the residual input domain, the processed residual signal can be transmitted to the plural-channel decoding unit 200b without undergoing a domain converting process.

FIG. 3 shows that in some embodiments the domain converting unit 500b converts the residual signal RM in the MDCT domain to the residual signal RQ in the QMF domain. In particular, the domain converting unit 500b is configured to convert the residual signal RM outputted from the residual decoding unit 400b to the residual signal RQ in the QMF domain.

As mentioned in the foregoing description, there can exist a plurality of downmix signal domains that can cause a time synchronization difference between a downmix signal and spatial information, which may need to be compensated. Various embodiments for compensating time synchronization differences are described below.

An audio signal process according to one embodiment of the present invention generates a plural-channel audio signal by decoding an encoded audio signal including a downmix signal and spatial information.

In the course of decoding, the downmix signal and the spatial information undergo different processes, which can cause different time delays.

In the course of encoding, the downmix signal and the spatial information can be encoded to be time synchronized.

In such a case, the downmix signal and the spatial information can be time synchronized by considering the domain in which the downmix signal processed in the downmix decoding unit 100, 100a or 100b is transmitted to the plural-channel decoding unit 200, 200a or 200b.

In some embodiments, a downmix coding identifier can be included in the encoded audio signal for identifying the domain in which the time synchronization between the downmix signal and the spatial information is matched. In such a case, the downmix coding identifier can indicate a decoding scheme of a downmix signal.

For instance, if a downmix coding identifier identifies an Advanced Audio Coding(AAC) decoding scheme, the encoded audio signal can be decoded by an AAC decoder.

In some embodiments, the downmix coding identifier can also be used to determine a domain for matching the time synchronization between the downmix signal and the spatial information.

In a method of processing an audio signal according to one embodiment of the present invention, a downmix signal can be processed in a domain different from a time-synchronization matched domain and then transmitted to the plural-channel decoding unit 200, 200a or 200b. In this case, the decoding unit 200, 200a or 200b compensates for the time synchronization between the downmix signal and the spatial information to generate a plural-channel audio signal.

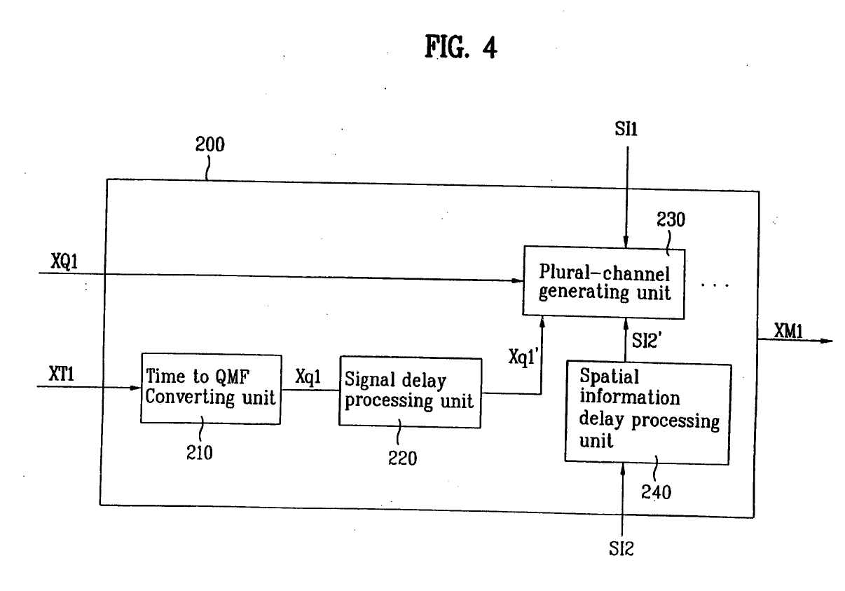

A method of compensating for a time synchronization difference between a downmix signal and spatial information is explained with reference to FIG. 1 and FIG. 4 as follows.

FIG. 4 is a block diagram of the plural-channel decoding unit 200 shown in FIG. 1.

Referring to FIG. 1 and FIG. 4, in a method of processing an audio signal according to one embodiment of the present invention, the downmix signal processed in the downmix decoding unit 100 (FIG. 1) can be transmitted to the plural-channel decoding unit 200 in one of two kinds of domains. In the present embodiment, it is assumed that a downmix signal and spatial information are matched together with time synchronization in a QMF domain. Other domains are possible.

In the example shown in FIG. 4, a downmix signal XQ1 processed in the QMF domain is transmitted to the plural-channel decoding unit 200 for signal processing.

The transmitted downmix signal XQ1 is combined with spatial information SI1 in a plural-channel generating unit 230 to generate the plural-channel audio signal XM1.

In this case, the spatial information SI1 is combined with the downmix signal XQ1 after being delayed by a time corresponding to time synchronization in encoding. The delay can be an encoding delay. Since the spatial information SI1 and the downmix signal XQ1 are matched with time synchronization in encoding, a plural-channel audio signal can be generated without a special synchronization matching process. That is, in this case, the spatial information ST1 is not delayed by a decoding delay.

In addition to XQ1, the downmix signal XT1 processed in the time domain is transmitted to the plural-channel decoding unit 200 for signal processing. As shown in FIG. 1, the downmix signal XQ1 in a QMF domain is converted to a downmix signal XT1 in a time domain by the domain converting unit 110, and the downmix signal XT1 in the time domain is transmitted to the plural-channel decoding unit 200.

Referring again to FIG. 4, the transmitted downmix signal XT1 is converted to a downmix signal Xq1 in the QMF domain by the domain converting unit 210.

In transmitting the downmix signal XT1 in the time domain to the plural-channel decoding unit 200, at least one of the downmix signal Xq1 and spatial information SI2 can be transmitted to the plural-channel generating unit 230 after completion of time delay compensation.

The plural-channel generating unit 230 can generate a plural-channel audio signal XM1 by combining a transmitted downmix signal Xql′ and spatial information SI2′.

The time delay compensation should be performed on at least one of the downmix signal Xq1 and the spatial information SI2, since the time synchronization between the spatial information and the downmix signal is matched in the QMF domain in encoding. The domain-converted downmix signal Xq1 can be inputted to the plural-channel generating unit 230 after being compensated for the mismatched time synchronization difference in a signal delay processing unit 220.

A method of compensating for the time synchronization difference is to lead the downmix signal Xq1 by the time synchronization difference. In this case, the time synchronization difference can be a total of a delay time generated from the domain converting unit 110 and a delay time of the domain converting unit 210.

It is also possible to compensate for the time synchronization difference by compensating for the time delay of the spatial information SI2. For this case, the spatial information SI2 is lagged by the time synchronization difference in a spatial information delay processing unit 240 and then transmitted to the plural-channel generating unit 230.

A delay value of substantially delayed spatial information corresponds to a total of a mismatched time synchronization difference and a delay time of which time synchronization has been matched. That is, the delayed spatial information is delayed by the encoding delay and the decoding delay. This total also corresponds to a total of the time synchronization difference between the downmix signal and the spatial information generated in the downmix decoding unit 100 (FIG. 1) and the time synchronization difference generated in the plural-channel decoding unit 200.

The delay value of the substantially delayed spatial information SI2 can be determined by considering the performance and delay of a filter (e.g., a QMF, hybrid filter bank).

For instance, a spatial information delay value, which considers performance and delay of a filter, can be 961 time samples. In case of analyzing the delay value of the spatial information, the time synchronization difference generated in the downmix decoding unit 100 is 257 time samples and the time synchronization difference generated in the plural-channel decoding unit 200 is 704 time samples. Although the delay value is represented by a time sample unit, it can be represented by a timeslot unit as well.

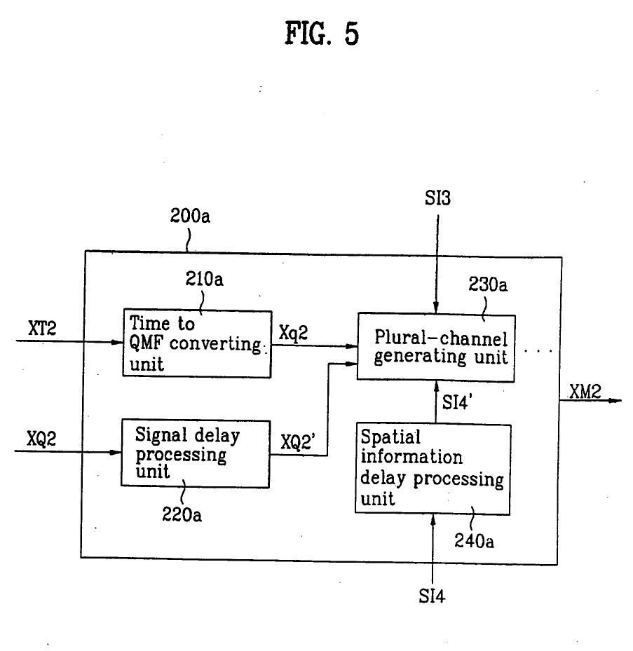

FIG. 5 is a block diagram of the plural-channel decoding unit 200a shown in FIG. 2.

Referring to FIG. 2 and FIG. 5, in a method of processing an audio signal according to one embodiment of the present invention, the downmix signal processed in the downmix decoding unit 100a can be transmitted to the plural-channel decoding unit 200a in one of two kinds of domains. In the present embodiment, it is assumed that a downmix signal and spatial information are matched together with time synchronization in a QMF domain. Other domains are possible. An audio signal, of which downmix signal and spatial information are matched on a domain different from a time domain, can be processed.

In FIG. 2, the downmix signal XT2 processed in a time domain is transmitted to the plural-channel decoding unit 200a for signal processing.

A downmix signal Xm in an MDCT domain is converted to a downmix signal XT2 in a time domain by the domain converting unit 110a.

The converted downmix signal XT2 is then transmitted to the plural-channel decoding unit 200a.

The transmitted downmix signal XT2 is converted to a downmix signal Xq2 in a QMF domain by the domain converting unit 210a and is then transmitted to a plural-channel generating unit 230a.

The transmitted downmix signal Xq2 is combined with spatial information S13 in the plural-channel generating unit 230a to generate the plural-channel audio signal XM2.

In this case, the spatial information S13 is combined with the downmix signal Xq2 after delaying an amount of time corresponding to time synchronization in encoding. The delay can be an encoding delay. Since the spatial information SI3 and the downmix signal Xq2 are matched with time synchronization in encoding, a plural-channel audio signal can be generated without a special synchronization matching process. That is, in this case, the spatial information SI3 is not delayed by a decoding delay.

In some embodiments, the downmix signal XQ2 processed in a QMF domain is transmitted to the plural-channel decoding unit 200a for signal processing.

The downmix signal Xm processed in an MDCT domain is outputted from a downmix decoding unit 100a. The outputted downmix signal Xm is converted to a downmix signal XQ2 in a QMF domain by the domain converting unit 300a. The converted downmix signal XQ2 is then transmitted to the plural-channel decoding unit 200a.

When the downmix signal XQ2 in the QMF domain is transmitted to the plural-channel decoding unit 200a, at least one of the downmix signal XQ2 or spatial information SI4 can be transmitted to the plural-channel generating unit 230a after completion of time delay compensation.

The plural-channel generating unit 230a can generate the plural-channel audio signal XM2 by combining a transmitted downmix signal XQ2′ and spatial information SI4′ together.

The reason why the time delay compensation should be performed on at least one of the downmix signal XQ2 and the spatial information SI4 is because time synchronization between the spatial information and the downmix signal is matched in the time domain in encoding. The domain-converted downmix signal XQ2 can be inputted to the plural-channel generating unit 230a after having been compensated for the mismatched time synchronization difference in a signal delay processing unit 220a.

A method of compensating for the time synchronization difference is to lag the downmix signal XQ2 by the time synchronization difference. In this case, the time synchronization difference can be a difference between a delay time generated from the domain converting unit 300a and a total of a delay time generated from the domain converting unit 110a and a delay time generated from the domain converting unit 210a.

It is also possible to compensate for the time synchronization difference by compensating for the time delay of the spatial information SI4. For such a case, the spatial information SI4 is led by the time synchronization difference in a spatial information delay processing unit 240a and then transmitted to the plural-channel generating unit 230a.

A delay value of substantially delayed spatial information corresponds to a total of a mismatched time synchronization difference and a delay time of which time synchronization has been matched. That is, the delayed spatial information SI4′ is delayed by the encoding delay and the decoding delay.

A method of processing an audio signal according to one embodiment of the present invention includes encoding an audio signal of which time synchronization between a downmix signal and spatial information is matched by assuming a specific decoding scheme and decoding the encoded audio signal.

There are several examples of a decoding schemes that are based on quality (e.g., high quality AAC) or based on power (e.g., Low Complexity AAC). The high quality decoding scheme outputs a plural-channel audio signal having audio quality that is more refined than that of the lower power decoding scheme. The lower power decoding scheme has relatively lower power consumption due to its configuration, which is less complicated than that of the high quality decoding scheme.

In the following description, the high quality and low power decoding schemes are used as examples in explaining the present invention. Other decoding schemes are equally applicable to embodiments of the present invention.

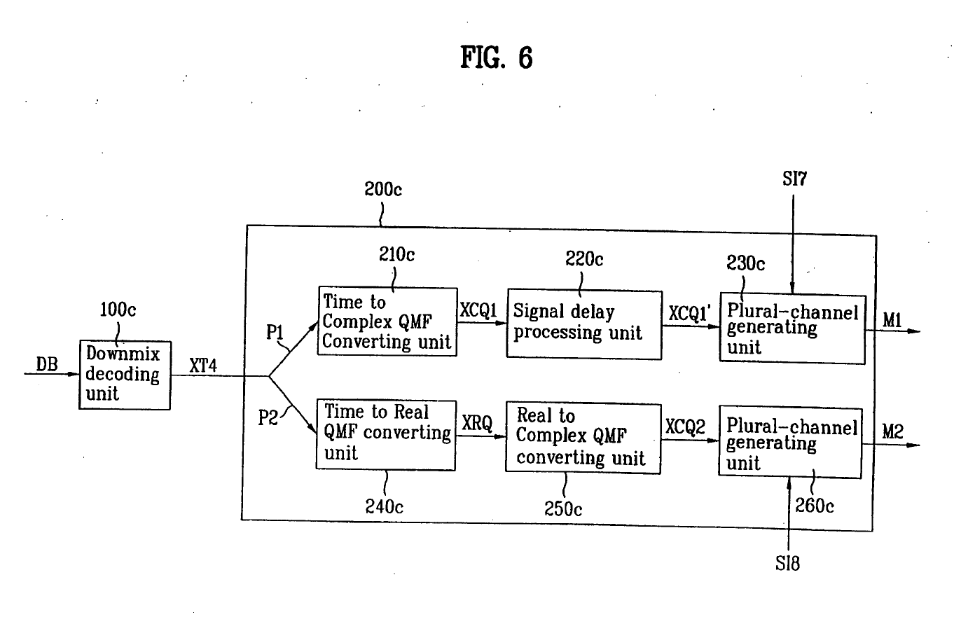

FIG. 6 is a block diagram to explain a method of decoding an audio signal according to another embodiment of the present invention.

Referring to FIG. 6, a decoding apparatus according to the present invention includes a downmix decoding unit 100c and a plural-channel decoding unit 200c.

In some embodiments, a downmix signal XT4 processed in the downmix decoding unit 100c is transmitted to the plural-channel decoding unit 200c, where the signal is combined with spatial information SI7 or SI8 to generate a plural-channel audio signal M1 or M2. In this case, the processed downmix signal XT4 is a downmix signal in a time domain.

An encoded downmix signal DB is transmitted to the downmix decoding unit 100c and processed. The processed downmix signal XT4 is transmitted to the plural-channel decoding unit 200c, which generates a plural-channel audio signal according to one of two kinds of decoding schemes: a high quality decoding scheme and a low power decoding scheme.

In case that the processed downmix signal XT4 is decoded by the low power decoding scheme, the downmix signal XT4 is transmitted and decoded along a path P2. The processed downmix signal XT4 is converted to a signal XRQ in a real QMF domain by a domain converting unit 240c.

The converted downmix signal XRQ is converted to a signal XQC2 in a complex QMF domain by a domain converting unit 250c. The XRQ downmix signal to the XQC2 downmix signal conversion is an example of complexity domain conversion.

Subsequently, the signal XQC2 in the complex QMF domain is combined with spatial information SI8 in a plural-channel generating unit 260c to generate the plural-channel audio signal M2.

Thus, in decoding the downmix signal XT4 by the low power decoding scheme, a separate delay processing procedure is not needed. This is because the time synchronization between the downmix signal and the spatial information is already matched according to the low power decoding scheme in audio signal encoding. That is, in this case, the downmix signal XRQ is not delayed by a decoding delay.

In case that the processed downmix signal XT4 is decoded by the high quality decoding scheme, the downmix signal XT4 is transmitted and decoded along a path P1. The processed downmix signal XT4 is converted to a signal XCQ1 in a complex QMF domain by a domain converting unit 210c.

The converted downmix signal XCQ1 is then delayed by a time delay difference between the downmix signal XCQ1 and spatial information SI7 in a signal delay processing unit 220c.

Subsequently, the delayed downmix signal XCQ1′ is combined with spatial information SI7 in a plural-channel generating unit 230c, which generates the plural-channel audio signal M1.

Thus, the downmix signal XCQ1 passes through the signal delay processing unit 220c. This is because a time synchronization difference between the downmix signal XCQ1 and the spatial information SI7 is generated due to the encoding of the audio signal on the assumption that a low power decoding scheme will be used.

The time synchronization difference is a time delay difference, which depends on the decoding scheme that is used. For example, the time delay difference occurs because the decoding process of, for example, a low power decoding scheme is different than a decoding process of a high quality decoding scheme. The time delay difference is considered until a time point of combining a downmix signal and spatial information, since it may not be necessary to synchronize the downmix signal and spatial information after the time point of combining the downmix signal and the spatial information.

In FIG. 6, the time synchronization difference is a difference between a first delay time occurring until a time point of combining the downmix signal XCQ2 and the spatial information SI8 and a second delay time occurring until a time point of combining the downmix signal XCQ1′ and the spatial information SI7. In this case, a time sample or timeslot can be used as a unit of time delay.

If the delay time occurring in the domain converting unit 210c is equal to the. delay time occurring in the domain converting unit 240c, it is enough for the signal delay processing unit 220c to delay the downmix signal XCQ1 by the delay time occurring in the domain converting unit 250c.

According to the embodiment shown in FIG. 6, the two decoding schemes are included in the plural-channel decoding unit 200c. Alternatively, one decoding scheme can be included in the plural-channel decoding unit 200c.

In the above-explained embodiment of the present invention, the time synchronization between the downmix signal and the spatial information is matched in accordance with the low power decoding scheme. Yet, the present invention further includes the case that the time synchronization between the downmix signal and the spatial information is matched in accordance with the high quality decoding scheme. In this case, the downmix signal is led in a manner opposite to the case of matching the time synchronization by the low power decoding scheme.

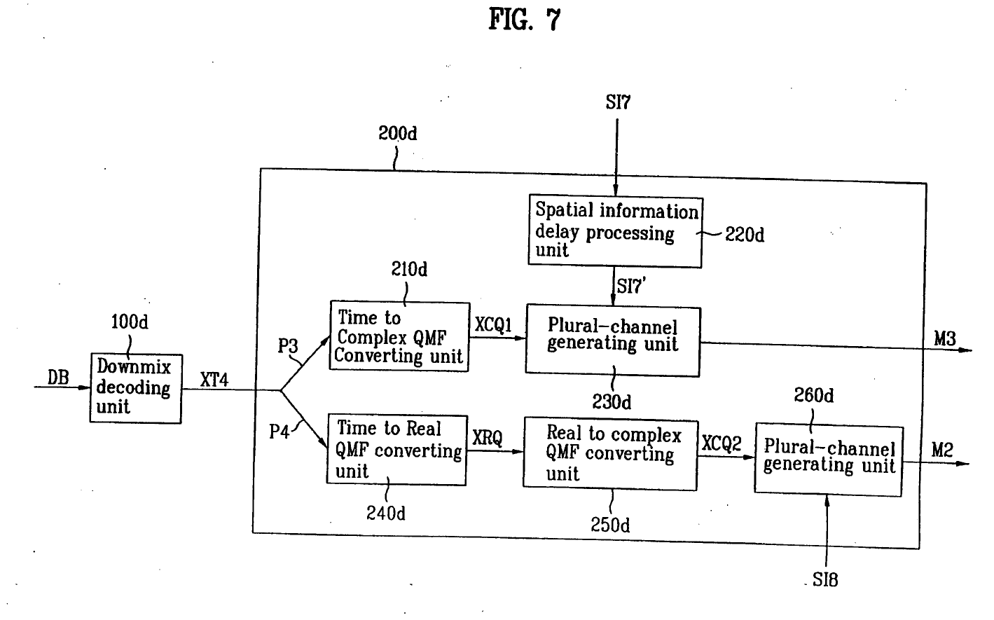

FIG. 7 is a block diagram to explain a method of decoding an audio signal according to another embodiment of the present invention.

Referring to FIG. 7, a decoding apparatus according to the present invention includes a downmix decoding unit 100d and a plural-channel decoding unit 200d.

A downmix signal XT4 processed in the downmix decoding unit 100d is transmitted to the plural-channel decoding unit 200d, where the downmix signal is combined with spatial information SI7′ or SI8 to generate a plural-channel audio signal M3 or M2. In this case, the processed downmix signal XT4 is a signal in a time domain.

An encoded downmix signal DB is transmitted to the downmix decoding unit 100d and processed. The processed downmix signal XT4 is transmitted to the plural-channel decoding unit 200d, which generates a plural-channel audio signal according to one of two kinds of decoding schemes: a high quality decoding scheme and a low power decoding scheme.

In case that the processed downmix signal XT4 is decoded by the low power decoding scheme, the downmix signal XT4 is transmitted and decoded along a path P4. The processed downmix signal XT4 is converted to a signal XRQ in a real QMF domain by a domain converting unit 240d.

The converted downmix signal XRQ is converted to a signal XQC2 in a complex QMF domain by a domain converting unit 250d. The XRQ downmix signal to the XCQ2 downmix signal conversion is an example of complexity domain conversion.

Subsequently, the signal XQC2 in the complex QMF domain is combined with spatial information SI8 in a plural-channel generating unit 260d to generate the plural-channel audio signal M2.

Thus, in decoding the downmix signal XT4 by the low power decoding scheme, a separate delay processing procedure is not needed. This is because the time synchronization between the downmix signal and the spatial information is already matched according to the low power decoding scheme in audio signal encoding. That is, in this case, the spatial information SI8 is not delayed by a decoding delay.

In case that the processed downmix signal XT4 is decoded by the high quality decoding scheme, the downmix signal XT4 is transmitted and decoded along a path P3. The processed downmix signal XT4 is converted to a signal XCQ1 in a complex QMF domain by a domain converting unit 210d.

The converted downmix signal XCQ1 is transmitted to a plural-channel generating unit 230d, where it is combined with the spatial information SI7′ to generate the plural-channel audio signal M3. In this case, the spatial information SI7′ is the spatial information of which time delay is compensated for as the spatial information SI7 passes through a spatial information delay processing unit 220d.

Thus, the spatial information SI7 passes through the spatial information delay processing unit 220d. This is because a time synchronization difference between the downmix signal XCQ1 and the spatial information SI7 is generated due to the encoding of the audio signal on the assumption that a low power decoding scheme will be used.

The time synchronization difference is a time delay difference, which depends on the decoding scheme that is used. For example, the time delay difference occurs because the decoding process of, for example, a low power decoding scheme is different than a decoding process of a high quality decoding scheme. The time delay difference is considered until a time point of combining a downmix signal and spatial information, since it is not necessary to synchronize the downmix signal and spatial information after the time point of combining the downmix signal and the spatial information.

In FIG. 7, the time synchronization difference is a difference between a first delay time occurring until a time point of combining the downmix signal XCQ2 and the spatial information SI8 and a second delay time occurring until a time point of combining the downmix signal XCQ1 and the spatial information SI7′. In this case, a time sample or timeslot can be used as a unit of time delay.

If the delay time occurring in the domain converting unit 210d is equal to the delay time occurring in the domain converting unit 240d, it is enough for the spatial information delay processing unit 220d to lead the spatial information SI7 by the delay time occurring in the domain converting unit 250d.

In the example shown, the two decoding schemes are included in the plural-channel decoding unit 200d. Alternatively, one decoding scheme can be included in the plural-channel decoding unit 200d.

In the above-explained embodiment of the present invention, the time synchronization between the downmix signal and the spatial information is matched in accordance with the low power decoding scheme. Yet, the present invention further includes the case that the time synchronization between the downmix signal and the spatial information is matched in accordance with the high quality decoding scheme. In this case, the downmix signal is lagged in a manner opposite to the case of matching the time synchronization by the low power decoding scheme.

Although FIG. 6 and FIG. 7 exemplarily show that one of the signal delay processing unit 220c and the spatial information delay unit 220d is included in the plural-channel decoding unit 200c or 200d, the present invention includes an embodiment where the spatial information delay processing unit 220d and the signal delay processing unit 220c are included in the plural-channel decoding unit 200c or 200d. In this case, a total of a delay compensation time in the spatial information delay processing unit 220d and a delay compensation time in the signal delay processing unit 220c should be equal to the time synchronization difference.

Explained in the above description are the method of compensating for the time synchronization difference due to the existence of a plurality of the downmix input domains and the method of compensating for the time synchronization difference due to the presence of a plurality of the decoding schemes.

A method of compensating for a time synchronization difference due to the existence of a plurality of downmix input domains and the existence of a plurality of decoding schemes is explained as follows.

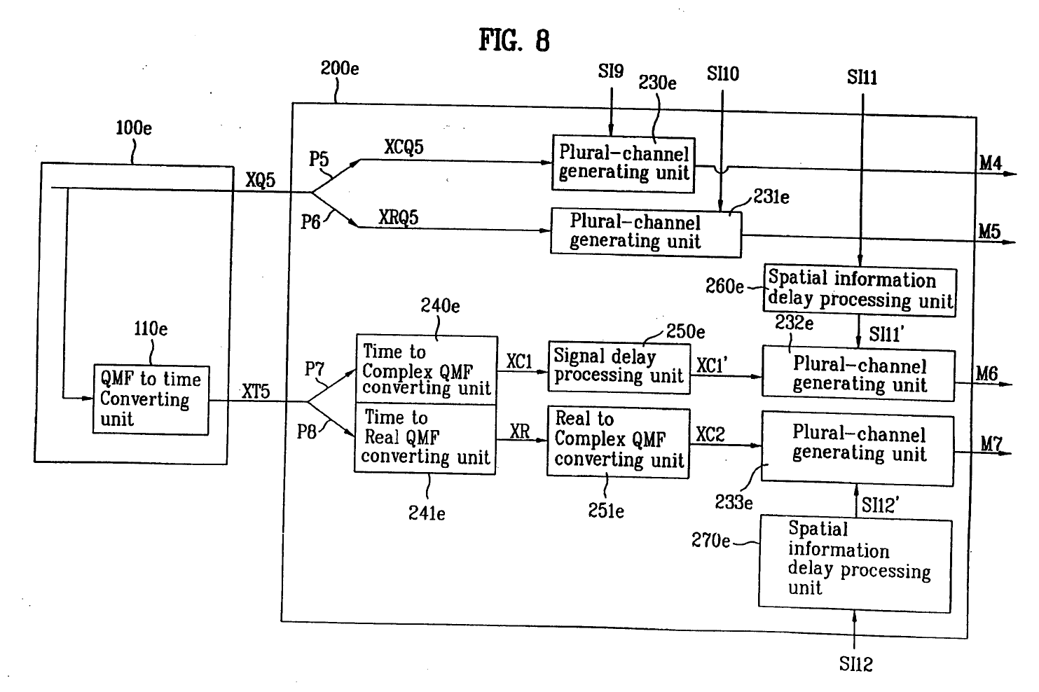

FIG. 8 is a block diagram to explain a method of decoding an audio signal according to one embodiment of the present invention.

Referring to FIG. 8, a decoding apparatus according to the present invention includes a downmix decoding unit 100e and a plural-channel decoding unit 200e.

In a method of processing an audio signal according to another embodiment of the present invention, a downmix signal processed in the downmix decoding unit 100e can be transmitted to the plural-channel decoding unit 200e in one of two kinds of domains. In the present embodiment, it is assumed that time synchronization between a downmix signal and spatial information is matched on a QMF domain with reference to a low power decoding scheme. Alternatively, various modifications can be applied to the present invention.

A method that a downmix signal XQ5 processed in a QMF domain is processed by being transmitted to the plural-channel decoding unit 200e is explained as follows. In this case, the downmix signal XQ5 can be any one of a complex QMF signal XCQ5 and real QMF single XRQ5. The XCQ5 is processed by the high quality decoding scheme in the downmix decoding unit 100e. The XRQ5 is processed by the low power decoding scheme in the downmix decoding unit 100e.

In the present embodiment, it is assumed that a signal processed by a high quality decoding scheme in the downmix decoding unit 100e is connected to the plural-channel decoding unit 200e of the high quality decoding scheme, and a signal processed by the low power decoding scheme in the downmix decoding unit 100e is connected to the plural-channel decoding unit 200e of the low power decoding scheme. Alternatively, various modifications can be applied to the present invention.

In case that the processed downmix signal XQ5 is decoded by the low power decoding scheme, the downmix signal XQ5 is transmitted and decoded along a path P6. In this case, the XQ5 is a downmix signal XRQ5 in a real QMF domain.

The downmix signal XRQ5 is combined with spatial information SI10 in a multi-channel generating unit 231e to generate a multi-channel audio signal M5.

Thus, in decoding the downmix signal XQ5 by the low power decoding scheme, a separate delay processing procedure is not needed. This is because the time synchronization between the downmix signal and the spatial information is already matched according to the low power decoding scheme in audio signal encoding.

In case that the processed downmix signal XQ5 is decoded by the high quality decoding scheme, the downmix signal XQ5 is transmitted and decoded along a path P5. In this case, the XQ5 is a downmix signal XCQ5 in a complex QMF domain. The downmix signal XCQ5 is combined with the spatial information S19 in a multi-channel generating unit 230e to generate a multi-channel audio signal M4.

Explained in the following is a case that a downmix signal XT5 processed in a time domain is transmitted to the plural-channel decoding unit 200e for signal processing.

A downmix signal XT5 processed in the downmix decoding unit 100e is transmitted to the plural-channel decoding unit 200e, where it is combined with spatial information SI11 or SI12 to generate a plural-channel audio signal M6 or M7.

The downmix signal XT5 is transmitted to the plural-channel decoding unit 200e, which generates a plural-channel audio signal according to one of two kinds of decoding schemes: a high quality decoding scheme and a low power decoding scheme.

In case that the processed downmix signal XT5 is decoded by the low power decoding scheme, the downmix signal XT5 is transmitted and decoded along a path P8. The processed downmix signal XT5 is converted to a signal XR in a real QMF domain by a domain converting unit 241e.

The converted downmix signal XR is converted to a signal XC2 in a complex QMF domain by a domain converting unit 250e. The XR downmix signal to the XC2 downmix signal conversion is an example of complexity domain conversion.

Subsequently, the signal XC2 in the complex QMF domain is combined with spatial information SI12′ in a plural-channel generating unit 233e, which generates a plural-channel audio signal M7.

In this case, the spatial information SI12′ is the spatial information of which time delay is compensated for as the spatial information SI12 passes through a spatial information delay processing unit 240e.

Thus, the spatial information SI12 passes through the spatial information delay processing unit 240e. This is because a time synchronization difference between the downmix signal XC2 and the spatial information SI12 is generated due to the audio signal encoding performed by the low power decoding scheme on the assumption that a domain, of which time synchronization between the downmix signal and the spatial information is matched, is the QMF domain. There the delayed spatial information SI12′ is delayed by the encoding delay and the decoding delay.

In case that the processed downmix signal XT5 is decoded by the high quality decoding scheme, the downmix signal XT5 is transmitted and decoded along a path P7. The processed downmix signal XT5 is converted to a signal XC1 in a complex QMF domain by a domain converting unit 240e.

The converted downmix signal XC1 and the spatial information SI11 are compensated for a time delay by a time synchronization difference between the downmix signal XC1 and the spatial information Sl11 in a signal delay processing unit 250e and a spatial information delay processing unit 260e, respectively.

Subsequently, the time-delay-compensated downmix signal XC1′ is combined with the time-delay-compensated spatial information SI11′ in a plural-channel generating unit 232e, which generates a plural-channel audio signal M6.

Thus, the downmix signal XC1 passes through the signal delay processing unit 250e and the spatial information SI11 passes through the spatial information delay processing unit 260e. This is because a time synchronization difference between the downmix signal XC1 and the spatial information SI11 is generated due to the encoding of the audio signal under the assumption of a low power decoding scheme, and on the further assumption that a domain, of which time synchronization between the downmix signal and the spatial information is matched, is the QMF domain.

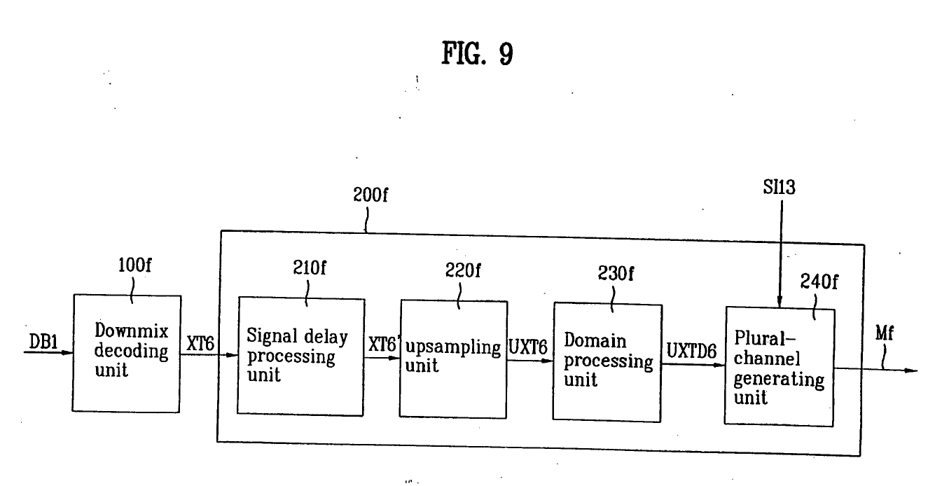

FIG. 9 is a block diagram to explain a method of decoding an audio signal according to one embodiment of the present invention.

Referring to FIG. 9, a decoding apparatus according to the present invention includes a downmix decoding unit 100f and a plural-channel decoding unit 200f.

An encoded downmix signal DB1 is transmitted to the downmix decoding unit 100f and then processed. The downmix signal DB1 is encoded considering two downmix decoding schemes, including a first downmix decoding and a second downmix decoding scheme.

The downmix signal DB1 is processed according to one downmix decoding scheme in downmix decoding unit 100f. The one downmix decoding scheme can be the first downmix decoding scheme.

The processed downmix signal XT6 is transmitted to the plural-channel decoding unit 200f, which generates a plural-channel audio signal Mf.

The processed downmix signal XT6′ is delayed by a decoding delay in a signal processing unit 210f. The downmix signal XT6′ can be a delayed by a decoding delay. The reason why the downmix signal XT6 is delayed is that the downmix decoding scheme that is accounted for in encoding is different from the downmix decoding scheme used in decoding.

Therefore, it can be necessary to upsample the downmix signal XT6′ according to the circumstances.

The delayed downmix signal XT6′ is upsampled in upsampling unit 220f. The reason why the downmix signal XT6′ is upsampled is that the number of samples of the downmix signal XT6′ is different from the number of samples of the spatial information SI13.

The order of the delay processing of the downmix signal XT6 and the upsampling processing of the downmix signal XT6′ is interchangeable.

The domain of the upsampled downmix signal UXT6 is converted in domain processing unit 230f. The conversion of the domain of the downmix signal UXT6 can include the F/T domain conversion and the complexity domain conversion.

Subsequently, the domain converted downmix signal UXTD6 is combined with spatial information SI13 in a plural-channel generating unit 260d, which generates the plural-channel audio signal Mf.

Explained in the above description is the method of compensating for the time synchronization difference generated between the downmix signal and the spatial information.

Explained in the following description is a method of compensating for a time synchronization difference generated between time series data and a plural-channel audio signal generated by one of the aforesaid methods.

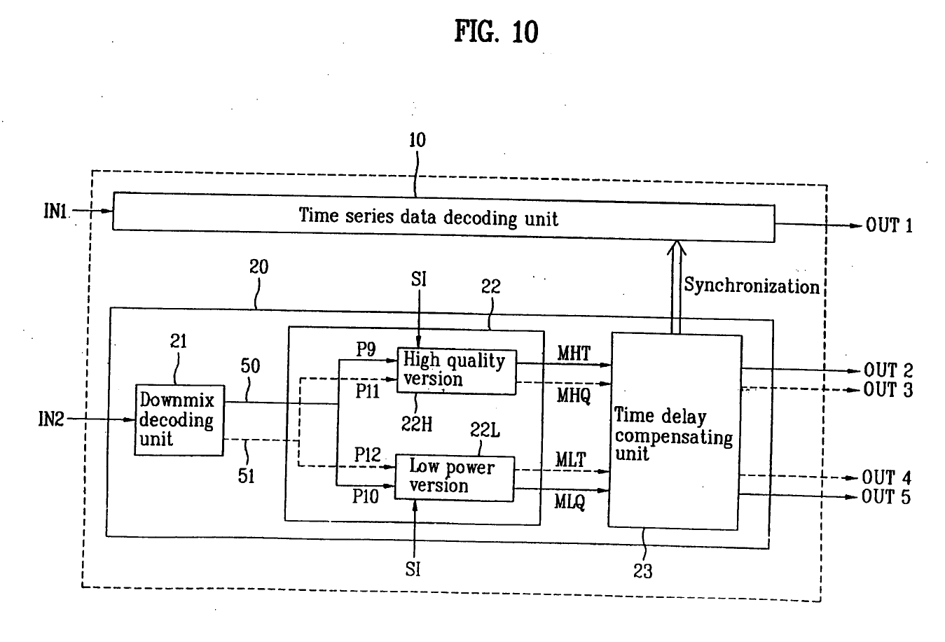

FIG. 10 is a block diagram of an apparatus for decoding an audio signal according to one embodiment of the present invention.

Referring to FIG. 10, an apparatus for decoding an audio signal according to one embodiment of the present invention includes a time series data decoding unit 10 and a plural-channel audio signal processing unit 20.

The plural-channel audio signal processing unit 20 includes a downmix decoding unit 21, a plural-channel decoding unit 22 and a time delay compensating unit 23.

A downmix bitstream IN2, which is an example of an encoded downmix signal, is inputted to the downmix decoding unit 21 to be decoded.

In this case, the downmix bit stream IN2 can be decoded and outputted in two kinds of domains. The output available domains include a time domain and a QMF domain. A reference number ‘50’ indicates a downmix signal decoded and outputted in a time domain and a reference number ‘51’ indicates a downmix signal decoded and outputted in a QMF domain. In the present embodiment, two kinds of domains are described. The present invention, however, includes downmix signals decoded and outputted on other kinds of domains.

The downmix signals 50 and 51 are transmitted to the plural-channel decoding unit 22 and then decoded according to two kinds of decoding schemes 22H and 22L, respectively. In this case, the reference number ‘22H’ indicates a high quality decoding scheme and the reference number ‘22L’ indicates a low power decoding scheme.

In this embodiment of the present invention, only two kinds of decoding schemes are employed. The present invention, however, is able to employ more decoding schemes.

The downmix signal 50 decoded and outputted in the time domain is decoded according to a selection of one of two paths P9 and P10. In this case, the path P9 indicates a path for decoding by the high quality decoding scheme 22H and the path P10 indicates a path for decoding by the low power decoding scheme 22L.

The downmix signal 50 transmitted along the path P9 is combined with spatial information SI according to the high quality decoding scheme 22H to generate a plural-channel audio signal MHT. The downmix signal 50 transmitted along the path P10 is combined with spatial information SI according to the low power decoding scheme 22L to generate a plural-channel audio signal MLT.

The other downmix signal 51 decoded and outputted in the QMF domain is decoded according to a selection of one of two paths P11 and P12. In this case, the path P11 indicates a path for decoding by the high quality decoding scheme 22H and the path P12 indicates a path for decoding by the low power decoding scheme 22L.

The downmix signal 51 transmitted along the path P11 is combined with spatial information SI according to the high quality decoding scheme 22H to generate a plural-channel audio signal MHQ. The downmix signal 51 transmitted along the path P12 is combined with spatial information SI according to the low power decoding scheme 22L to generate a plural-channel audio signal MLQ.

At least one of the plural-channel audio signals MHT, MHQ, MLT and MLQ generated by the above-explained methods undergoes a time delay compensating process in the time delay compensating unit 23 and is then outputted as OUT2, OUT3, OUT4 or OUT5.

In the present embodiment, the time delay compensating process is able to prevent a time delay from occurring in a manner of comparing a time synchronization mismatched plural-channel audio signal MHQ, MLT or MKQ to a plural-channel audio signal MHT on the assumption that a time synchronization between time-series data OUT1 decoded and outputted in the time series decoding unit 10 and the aforesaid plural-channel audio signal MHT is matched. Of course, if a time synchronization between the time series data OUT1 and one of the plural-channel audio signals MHQ, MLT and MLQ except the aforesaid plural-channel audio signal MHT is matched, a time synchronization with the time series data OUT1 can be matched by compensating for a time delay of one of the rest of the plural-channel audio signals of which time synchronization is mismatched.

The embodiment can also perform the time delay compensating process in case that the time series data OUT1 and the plural-channel audio signal MHT, MHQ, MLT or MLQ are not processed together. For instance, a time delay of the plural-channel audio signal is compensated and is prevented from occurring using a result of comparison with the plural-channel audio signal MLT. This can be diversified in various ways.

Accordingly, the present invention provides the following effects or advantages.

First, if a time synchronization difference between a downmix signal and spatial information is generated, the present invention prevents audio quality degradation by compensating for the time synchronization difference.

Second, the present invention is able to compensate for a time synchronization difference between time series data and a plural-channel audio signal to be processed together with the time series data of a moving picture, a text, a still image and the like.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of processing an audio signal, comprising:
receiving an audio signal including a downmix signal and spatial information;
converting the downmix signal from a first domain to a second domain; and
combining the converted downmix signal and the spatial information,
wherein at least one of the combined downmix signal and the combined spatial information is delayed by an amount of time that includes an elapsed time of the converting.

2. The method of claim 1, wherein the downmix signal or the spatial information is time delayed by at least one of an encoding delay and a decoding delay.

3. The method of claim 2, wherein the converting includes at least one of a time domain to frequency domain conversion and a complexity domain conversion.

4. The method of claim 3, wherein the frequency domain is a Quadrature Mirror Filter (QMF) domain.

5. The method of claim 3, wherein the complexity domain conversion includes at least one of converting a real Quadrature Mirror Filter (QMF) domain signal to a complex QMF domain signal and converting a complex QMF domain signal to a real QMF domain signal.

6. The method of claim 1, further comprising:
generating a plural-channel signal using the combined signal; and
compensating for a time synchronization difference between the plural-channel signal and time series data.

7. The method of claim 6, wherein the time series data includes at least one of a moving picture, a still image and text.

8. A system for generating a plural-channel audio signal, comprising:
a downmix decoder configured for processing an encoded downmix signal;
a plural-channel decoder operatively coupled to the downmix decoder and configured for generating a plural-channel audio signal;
a domain converter included in the plural-channel decoder and configured for converting the downmix signal from a first domain to a second domain; and
a delay processor included in the plural-channel decoder and configured for compensating the downmix signal for time delay resulting from converting the downmix signal.

9. The system of claim 8, wherein the delay processor includes at least one of a signal delay processor configured for delaying the downmix signal and a spatial information delay processor configured for delaying spatial information.

10. The system of claim 9, further comprising:
a time delay compensator configured for compensating for a time synchronization difference between the plural-channel signal and time-series data.

11. A computer-readable medium having instructions stored thereon, which, when executed by a processor, causes the processor to perform the operations of:
receiving an audio signal including a downmix signal and spatial information;
converting the downmix signal from a first domain to a second domain;
compensating at least one of the converted downmix signal and the combined signal for time delay resulting from converting the downmix signal; and
combining the converted downmix signal and the spatial information into a combined signal.

12. The computer-readable medium of claim 11, wherein the downmix signal or the spatial information is time delayed by at least one of an encoding delay and a decoding delay.

13. The computer-readable medium of claim 12, wherein the converting includes at least one of a time domain to frequency domain conversion and a complexity domain conversion.

14. The computer-readable medium of claim 13, wherein the frequency domain is a Quadrature Mirror Filter (QMF) domain.

15. The computer-readable medium of claim 13, wherein the complexity domain conversion includes at least one of converting a real Quadrature Mirror Filter (QMF) domain signal to a complex QMF domain signal and converting a complex QMF domain signal to a real QMF domain signal.

16. The computer-readable medium of claim 11, further comprising:
generating a plural-channel signal using the combined signal; and
compensating for a time synchronization difference between the plural-channel signal and time-series data.

17. The computer-readable medium of claim 16, wherein the time-series data includes at least one of a moving picture, a still image and text.

18. A system for generating a plural-channel audio signal, comprising:
a domain converter configured for converting a downmix signal from a first domain to a second domain;
a delay processor operatively coupled to the domain converter and configured for compensating the converted downmix signal for time delay resulting from the conversion; and
a plural-channel audio processor operatively coupled to the delay processor and configured for generating a plural-channel audio signal from the compensated downmix signal and spatial information.

19. The system of claim 18, wherein the delay processor includes at least one of a signal delay processor configured for delaying the downmix signal and a spatial information delay processor configured for delaying the spatial information.

20. The system of claim 19, further comprising:
a time delay compensator configured for compensating for a time synchronization difference between the plural-channel audio signal and time-series data.

21. A method of processing an audio signal, comprising:
receiving an audio signal including a downmix signal and spatial information;
converting the downmix signal from a first domain to a second domain;
compensating at least one of the converted downmix signal and the combined signal for time delay resulting from converting the downmix signal; and
combining the converted downmix signal and the spatial information into a combined signal.
